(19) United States
(12) Patent Application Publication
(10) Pub. No.: US 2019/0248033 A1
(43) Pub. Date: Aug. 15, 2019

(54) COMBINATION SCISSORS WITH CUTTING KNIFE

(71) Applicant: Yena Park, Walnut Creek, CA (US)

(72) Inventor: Youn-seok Choi, Seoul (KR)

(21) Appl. No.: 15/896,620

(22) Filed: Feb. 14, 2018

(51) Int. Cl. B26B 11/00; B26B 5/00; B26B 13/22

(52) U.S. Cl. CPC B26B 11/005; B26B 13/22; B26B 5/003

(57) ABSTRACT

Disclosed herein is a combination scissors and cutting knife such as a multi-purpose utility knife can include a first elongated member. The first elongated member also includes a handle at a first end and a scissor blade section extending therefrom. A first pivotal structure can be arranged between the first end and the scissor blade section. The combination scissors and cutting knife can include a second elongated member which also includes a handle at a first end and a scissor blade section extending therefrom. The second elongated structure can also include a second pivotal structure arranged between the first end and the scissor blade section. The first and second pivotal structures are configured to pivotally couple together. The second elongated structure can also include a cutting knife housing extending from the first end to the scissor blade section. The cutting knife housing can include a retractable cutting knife arranged within the cutting knife housing.

### TECHNICAL FIELD

The present invention relates to scissors combined with auxiliary implements, and, more particularly, scissors combined with a multi-purpose utility knife.

### BACKGROUND

Scissors and cutting knives such as multi-purpose utility knifes have conventionally been manufactured and sold separately. Many activities, such as sewing, scrapbooking, model building, construction, and general craft activities, require the utility of scissors as well as the utility of a cutting knife. Thus, the industry has produced various innovations which combine the utility of scissors and cutting knives into a single tool.

A conventional example is the combination of a multiple blade pocket knife with an included scissor element. In this example, the scissor element folds out of the handle in a similar fashion as does the other knife elements of the pocket knife. The scissor element of these pocket knives is typically very small due to the restriction of the size of the handle in which it is housed in non-operation mode. Thus, the multiple blade pocket knife with an included scissor element is restricted to cutting very small objects.

In another design, the scissors are configured to have one longer, exposed blade, and one shorter blade. In this design, the longer blade can be used as a cutting knife when the scissors are in a closed position. These blades are susceptible to dulling and are not easily sharpened.

### SUMMARY

Disclosed herein is a combination scissors and multi-purpose utility knife tool. The tool comprises two handles with scissor blades extending from the handles. The two handles are pivotally connected after the handle such that the two handles with blades can be used as scissors. At least one of the handles with blades includes an extendable cutting knife portion having a housing and a cutting knife. The cutting knife can be extended via a button and slot configuration within the housing. When the scissors are closed and the cutting knife is extended, the tool can be used as a box cutter, razor blade knife, or similar open-blade type cutter. When the cutting knife is in the retracted position, the scissors can be used as a pair of scissors.

In one embodiment, a combination scissors and cutting knife can include a first elongated member. The first elongated member also includes a handle at a first end and a scissor blade section extending therefrom. A first pivotal structure can be arranged between the first end and the scissor blade section. The combination scissors and cutting knife can include a second elongated member which also includes a handle at a first end and a scissor blade section extending therefrom. The second elongated structure can also include a second pivotal structure arranged between the first end and the scissor blade section. The first and second pivotal structures are configured to pivotally couple together. The second elongated structure can also include a cutting knife housing extending from the first end to the scissor blade section. The cutting knife housing can include a retractable cutting knife arranged within the cutting knife housing.

In one embodiment, the cutting knife housing includes a slot and button, wherein the button is rigidly attached to the cutting knife and further engages with the slot. In one embodiment, the slot and button engagement can be a cog-type engagement to releasably hold the cutting knife in different positions (i.e, extending out of the scissors different lengths). In another embodiment, the slot and button engagement can be a ratcheting engagement.

In one embodiment, the button can be arranged on a side of the second elongated member. In another embodiment, the button can be arranged on a top portion of the second elongated member. In yet another embodiment, the button can be arranged to be accessible from the top and side of the second elongated member.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is an isometric view of a combination scissors and cutting knife, according to embodiments.

FIGS. 2A and 2B are isometric views of a combination scissors and cutting knife, when scissors are in an open scissor position, according to embodiments.

FIG. 3 is an exploded view of a combination scissors and cutting knife, according to embodiments.

FIG. 4A is a front view of a combination scissors and cutting knife, according to embodiments.

FIGS. 4B and 4C are isometric views of a combination scissors and cutting knife, when scissors are in an open scissor position, according to embodiments.

FIG. 5 is a flowchart for replacement of a cutting knife, according to embodiments. FIGS. 6A-6N depict various embodiments of the invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

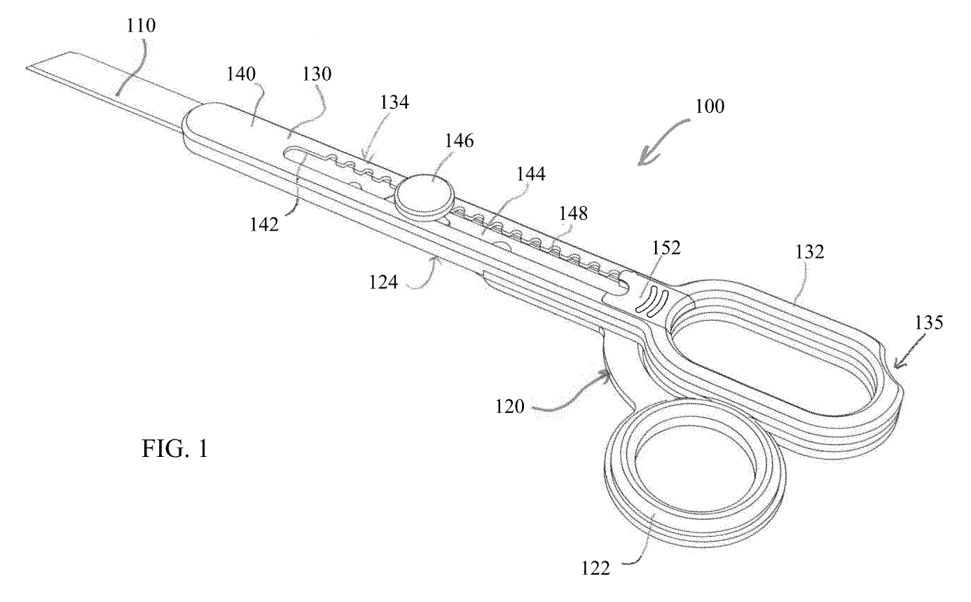

Disclosed herein is a scissors combined with a cutting knife. FIGS. 1-5 depict a scissors including a retractable cutting knife according to various embodiments.

FIGS. 1-3 depict a scissors 100 including a cutting knife 110 such as a multi-purpose utility knife, according to embodiments. Scissors 100 includes a first elongated member 120. Elongated member 120 further includes a handle 122 at a first end and a scissor blade section 124 extending therefrom. In some embodiments, handle 122 can be circular to accommodate a single finger, such as a thumb. In alternative embodiments, handle 122 may be oblong, or any other suitable shape, and can also be open at a rear end. A pivotal structure 126 can be arranged between handle 122 and scissor blade section 124. Scissors 100 also includes a second elongated member 130.

Elongated member 130 includes a handle 132 at a first end and a scissor blade section 134 extending therefrom. In some embodiments, handle 132 can be oblong to accommodate one or more fingers, such as an index, middle, and ring finger. In alternative embodiments, handle 132 may be circular, or any other suitable shape, and can also be open at a rear end. Handle 132 may also include a finger detent 135 to accommodate one or more fingers placed on the exterior of handle 132, such as a pinky finger. A pivotal structure 136 can be arranged between handle 132 and scissor blade section 134. Elongated member 130 also includes a cutting knife housing 140. In some embodiments, cutting knife housing 140 can form part of handle 132 such that cutting knife housing 140 runs the entire length of elongated member 130. In some embodiments, cutting knife housing 140 can be an opening formed within a unitary elongated member 130 as a single monolithic structure, or alternatively, cutting knife housing 140 and elongated member 130 can be two separate members that couple together at a weldment. In alternative embodiments, cutting knife housing 140 only runs the length of scissor blade section 134 and excludes a handle section or only runs a portion of a length of the scissor blade section 134. Although described herein as being formed within elongated member 130, in other embodiments cutting knife housing 140 can be formed within elongate member 120.

Cutting knife housing 140 can include a channel 142 and a slot 144 formed in elongated member 130 as well as a distal aperture 143 through which the knife 110 can be extended. Channel 142 is configured to contain and provide a slidable support for cutting knife 110. In other words, cutting knife 110 can be moved along the length of channel 142 as channel 142 provides lateral support for cutting knife 110. To aid in movement of cutting knife 110 within channel 142, a cutting knife button 146 is coupled to an outer side of cutting knife 110. Button 146 is configured to couple to cutting knife 110 through slot 144 in elongated member 130. In various embodiments, slot 144 includes a plurality of cogs 148. In such embodiments, cutting knife button 146 is configured to flexibly depress such that an engagement feature 150 can selectively engage with cogs 148 to hold the button 146 and therefore the knife 110 in place and therefore in a given position (e.g. extended out of the elongated member 130 a given distance). In embodiments, when button 146 is depressed, cutting knife 110 is free to move through channel 142. Conversely, when button 146 is not depressed and is in its rest position, engagement feature 150 is engaged with one of cogs 148 such that cutting knife 110 is restricted from any movement. When cutting knife 110 is extended outside of channel 142 and in a rest position, the user can use scissors 100 as an open cutting knife with cutting blade 110, rather than a scissors. Slot 142 can include an end portion 141 defined in elongated member 130 that limits a distance that cutting knife 110 can be extended by preventing further distal movement of button 146. In an alternative embodiment, engagement feature 150, cogs 148, and button 146 can be replaced by a tightening nut or other suitable means for selectively restricting movement of cutting knife 110 with respect to channel 142.

In some embodiments, scissors can also include a channel cap 152 releasably attachable to elongate member 130 at a rear end of channel 142. Channel cap 152 is configured to be selectively removable. Cutting knife 110 can be replaced if dull or worn by removing channel cap 152 and sliding cutting knife 110 toward handle 132 until cutting knife 110 is free of channel 142.

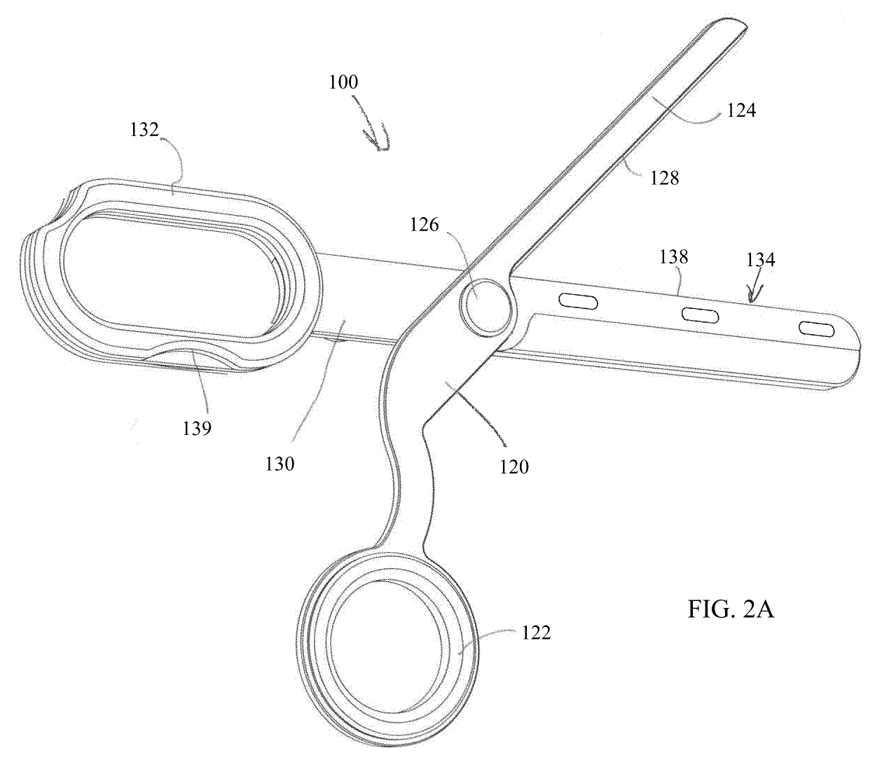

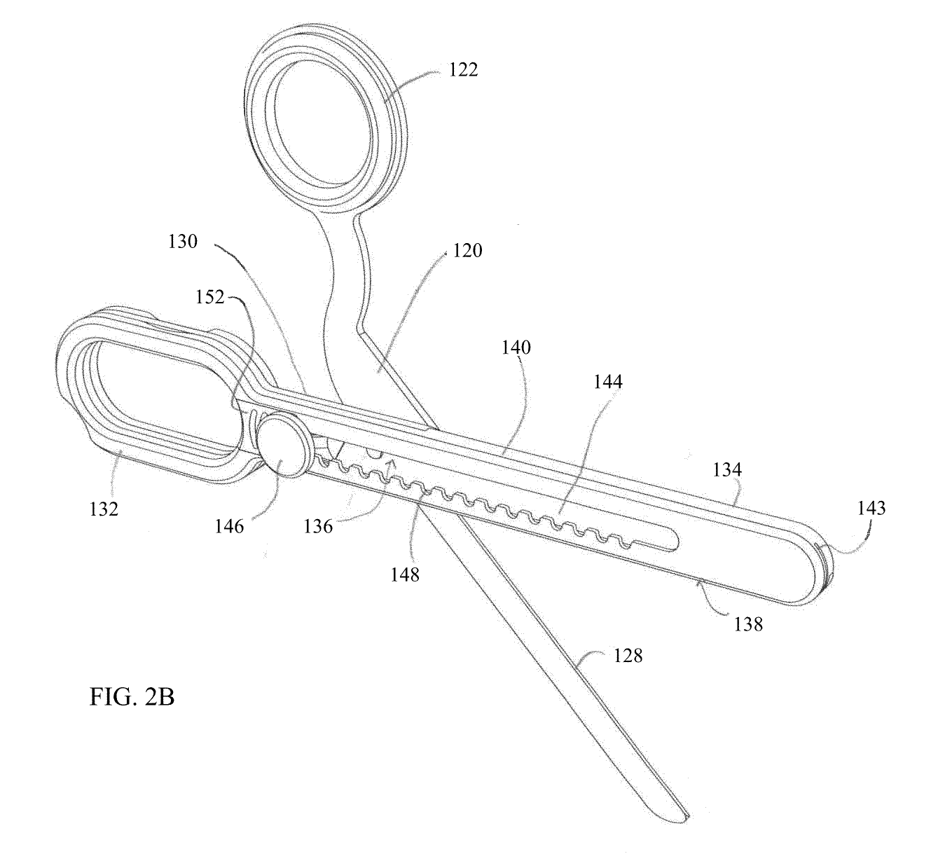

FIGS. 2A and 2B depict scissors 100 including a cutting knife 110, when scissors 100 is in an open scissor position. Pivotal structures 126 and 136 serve as the fulcrum for leverage when force is applied by the user at handles 122 and 132. Pivotal structure 136 can include an aperture suitable to accept a rivet or other cylindrical member. In other embodiments, pivotal structure 136 can be a cylindrical peg or boss, while pivotal structure 126 is an aperture configured to accept the peg of pivotal structure 136. Scissor blade sections 124 and 134 further includes respective scissor edges 128, 138. Elongated member 120 and elongated member 130 are configured to pivotally couple at pivotal structures 126 and 136, respectively. Scissor edges 128 and 138 are configured to slide past each other when force is applied by the user to handles 122 and 132, when in an open position, to affect scissor type cutting. When scissors 100 are in a closed position, handle detent 139 of handle 132 serves as a rest area for the exterior of handle 122.

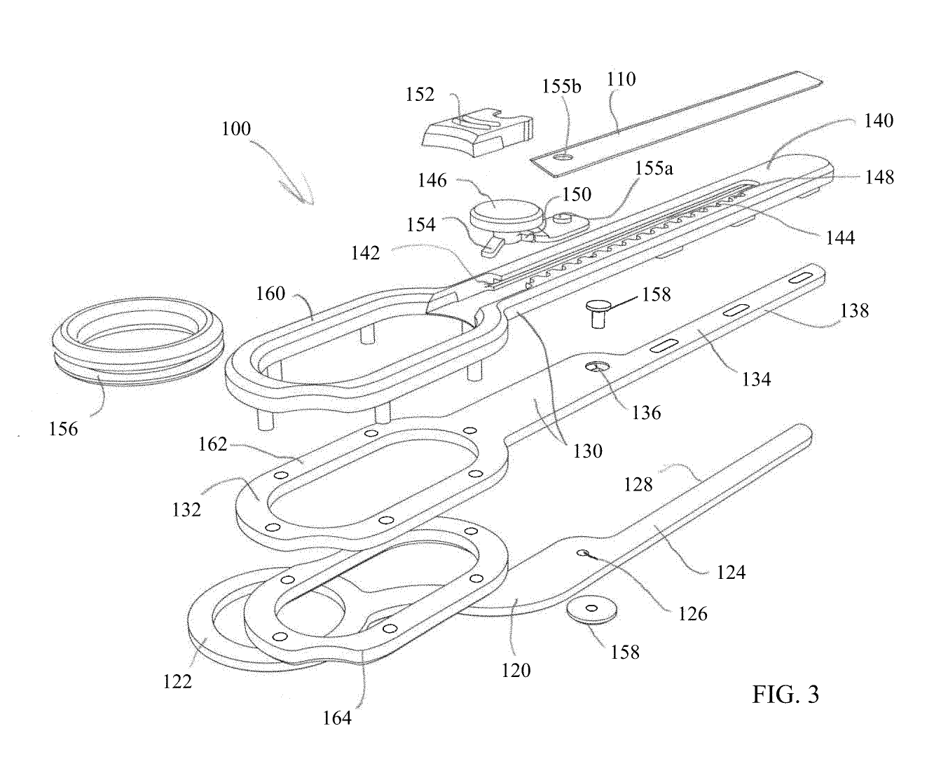

FIG. 3 depicts an exploded view of scissors 100, according to embodiments. When cutting knife 110 is in retracted position and cutting knife button 146 is not depressed, a button spring 154 ensures that engagement feature 150 is engaged with one of the plurality of cogs 148. Button spring 154 ensures that cutting knife 110 does not unexpectedly retract into cutting knife housing 140. Depressing the button 146 compresses the button spring 154 to force the engagement feature 150 into the housing 140 away from the cogs 148, which enables sliding movement of the button 146 and knife 110. Cutting knife button removably couples to cutting knife 110 using peg 155a and accompanying peg aperture 155b which is arranged on cutting knife 110.

First elongated member 120 can also includes handle liner 156. Handle liner 156 can be made of synthetic or natural rubber, such as, for example, silicon, to ensure a comfortable and stable grip for the user. Handle liner 156 can also be made of any other suitable material, such as various plastics or metal. Second elongate member 130 can also include a handle liner.

In one embodiment, pivotal structures 126 and 136 can be apertures suitable for a rivet assembly 158. In alternative embodiments, pivotal structures 126 and 136 can comprise a screw and nut or other suitable pivotal fixation method. During assembly, first elongated member 120 and second elongated member 130 are aligned at pivotal structures 126 and 136 and pivotally coupled together with rivet assembly 158 by inserting a cylindrical portion of a peg also having a head through pivotal structure 126 and 136 and an aperture in a washer.

In some embodiments, second elongated member 130 can comprise a cutting knife housing component 160, scissor component 162, and handle retainer 164. During assembly, cutting knife housing component 160, scissor component 162, and handle retainer 164 can be coupled together using rivets, screws and nuts, melt weldments, press-fit pegs and apertures, or any other suitable means of fixation. In some embodiments, cutting knife housing 140 can be formed within cutting knife housing component 160 with cutting knife housing component 160 unitarily forming a monolithic handle portion and scissor portion extending therefrom with cutting knife housing unitarily formed within cutting knife housing component. In alternative embodiments, second elongated member 130 can be monolithic such that what is depicted as separate cutting knife housing component 160, scissor component 162, and handle retainer 164 can be unitarily formed from a single monolithic structure. In one embodiment, cutting knife housing component 160 and handle retainer 164 can be made of a plastic or metal material and scissor component 162 can be made of a metal material such as stainless steel or steel.

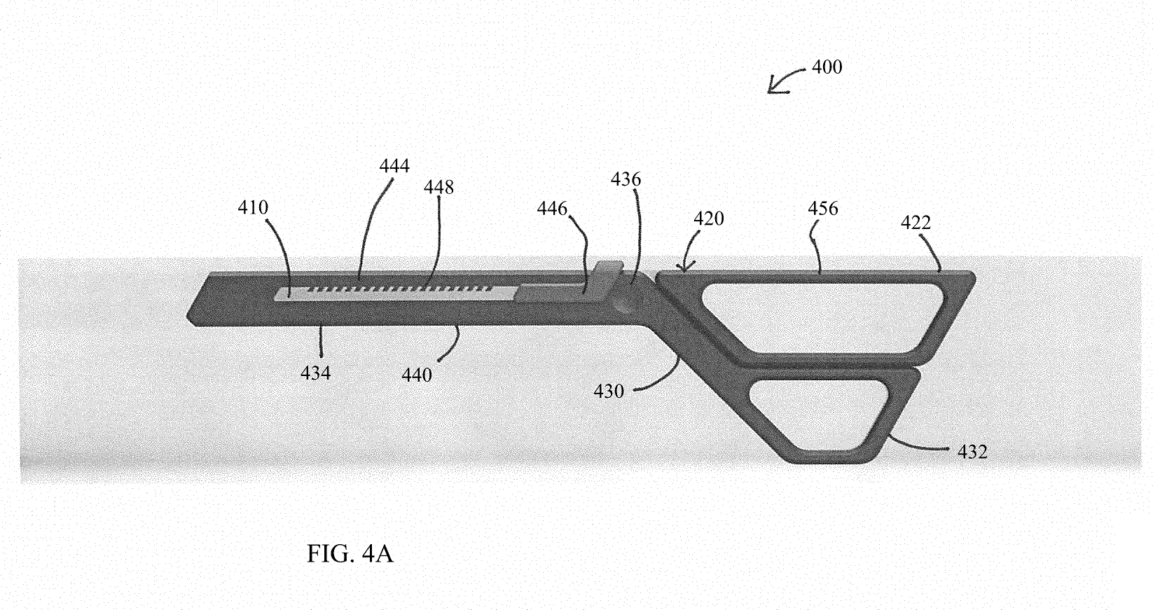

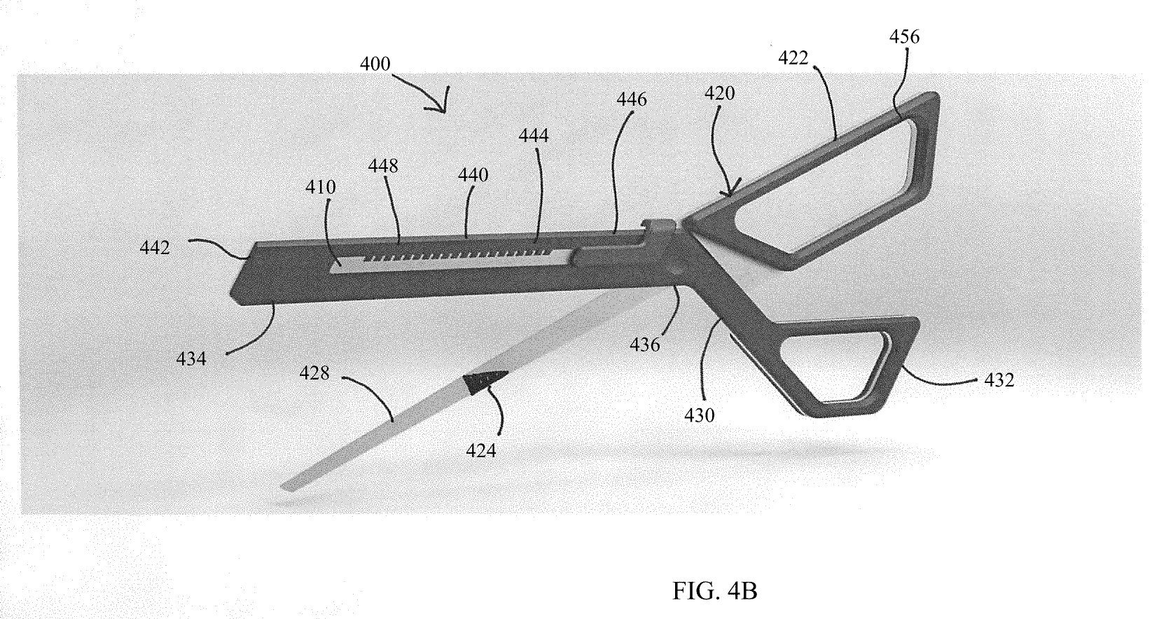

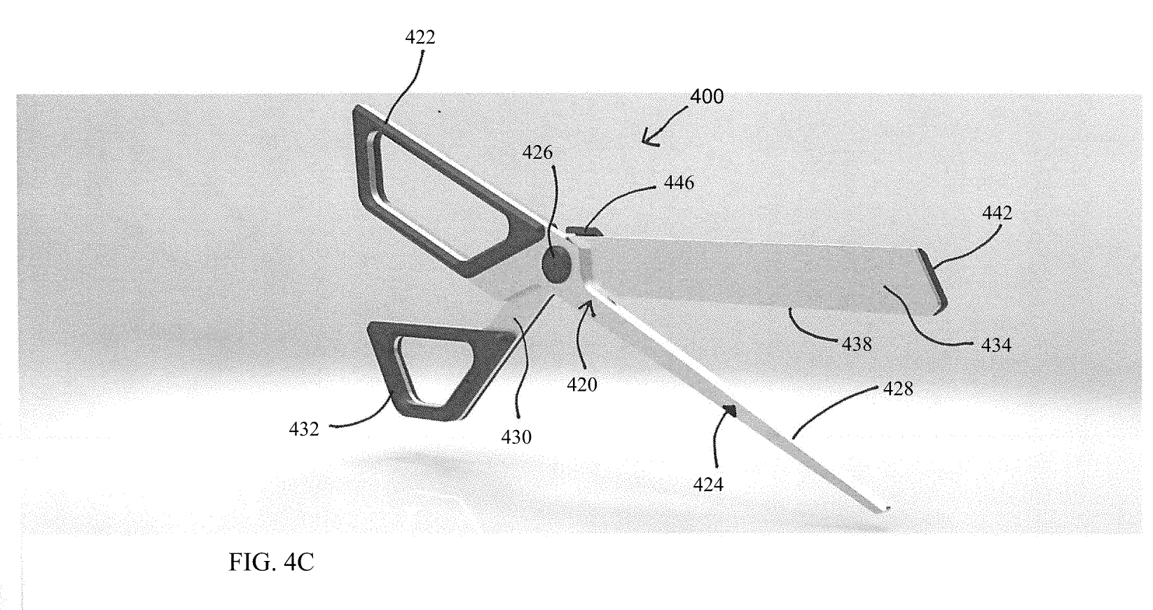

FIGS. 4A-4C depict an alternative embodiment of a combination scissors 400 with cutting knife 410 such as a multi-purpose utility knife that is similar in many respects to combination scissors 100. Scissors 400 include cutting knife 410 and a first elongated member 420. First elongated member 420 includes a handle 422, a scissor blade section 424, and a pivotal structure 426. Scissor blade section 422 includes a scissor edge 428. Scissors 400 also include a second elongated member 430. Second elongated member 430 includes a handle 432, a scissor blade section 434, and a pivotal structure 436. Scissor blade section 432 includes a scissor edge 438. Second elongated member 430 also comprises cutting knife housing 440. Cutting knife housing 440 includes a channel 442 and a slot 444. In embodiments, cutting knife 410 is coupled to cutting knife slider 446, which travels through slot 444. Slot 444 can include a plurality of cogs 448. In alternative embodiments, slot 444 can include teeth, a ratchet assembly, or other suitable means of selectively securing cutting knife 410. In an embodiment, cutting knife slider 446 can engage with cogs 448 via an engagement feature. In an embodiment, an engagement feature can be a cog configured to selectively rest in between cogs 448.

In this embodiment, slider 446 is arranged such that it wraps over the top of second elongated member 430. In this embodiment, slider 446 can be depressed from a top direction to enable sliding movement of the slider 446 for adjusting the length of the blade 110 extending outwardly from the device, as opposed to depressing button 146 of scissors 100 from a side angle as described in the previous embodiment. Depressing slider 446 can release the engagement feature from cogs 448 and allow cutting knife 410 to slidably move through channel 442.

When cutting knife 410 is in the retracted position and cutting knife slider 446 is not depressed, a button spring ensures that engagement feature 450 is engaged with one of the plurality of cogs 448. Button spring 454 ensures that cutting knife 410 does not unexpectedly retract into cutting knife housing 440.

First elongated member 420 also includes handle liner 456. Handle liner 456 can be made of synthetic or natural rubber to ensure a comfortable and stable grip for the user. Handle liner 456 can also be made of any other suitable material, such as various plastics or metal.

In one embodiment, first elongated member 420 and second elongated member 430 include pivotal structures 426 and 436, respectively, that can be apertures suitable for a rivet assembly. In alternative embodiments, pivotal structures 426 and 436 can comprise a screw and nut or other suitable pivotal fixation method. During assembly, first elongated member 420 and second elongated member 430 are aligned at pivotal structures 426 and 436 and pivotally coupled together with the rivet assembly.

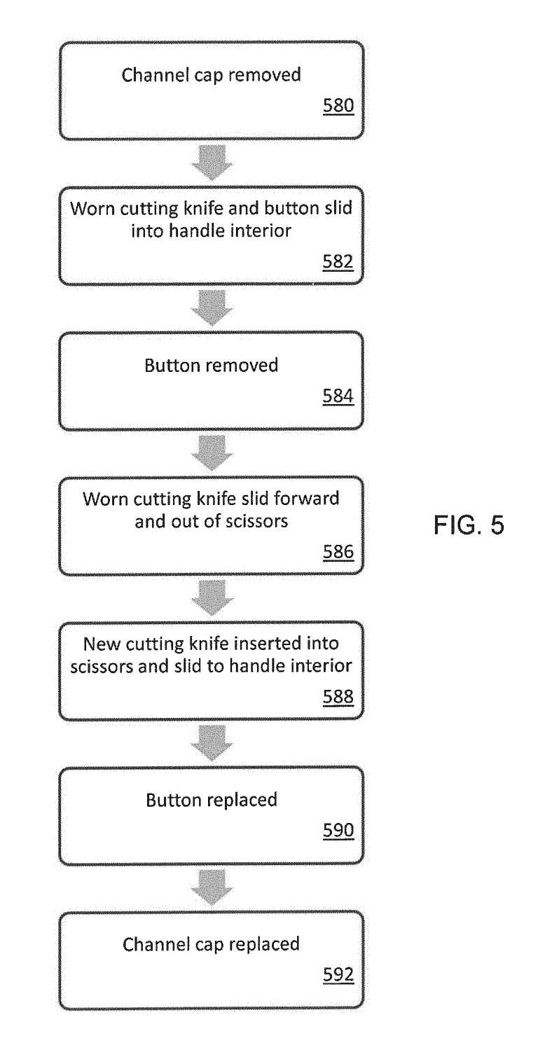

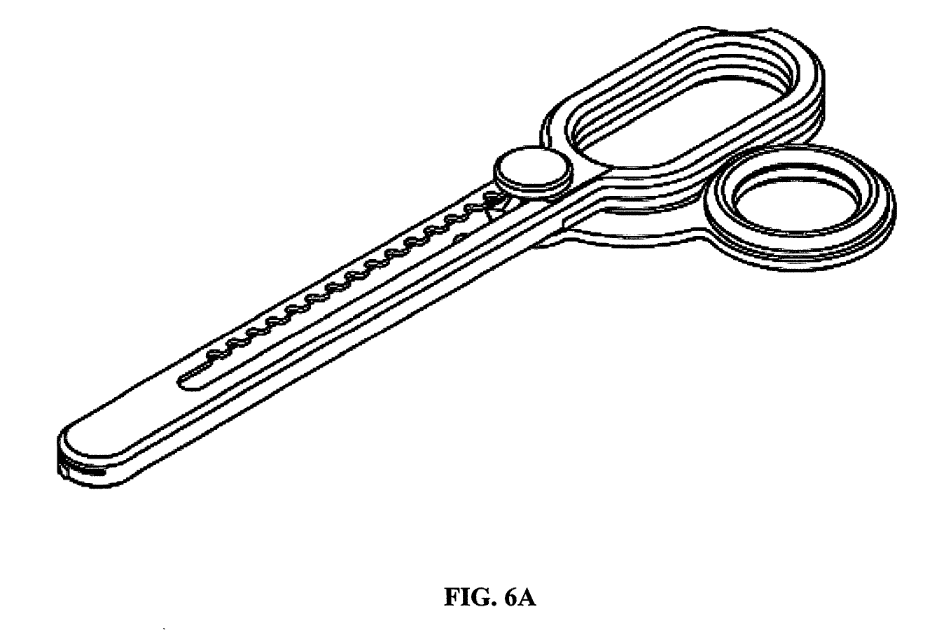

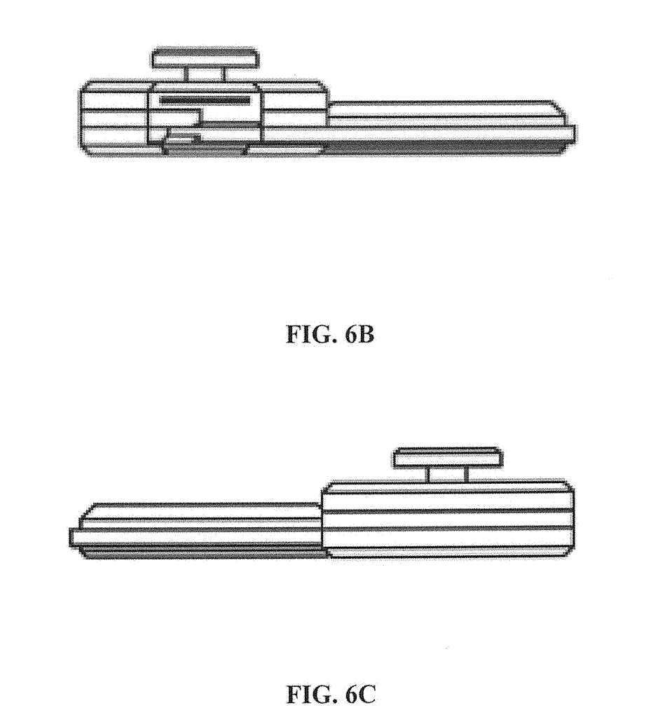

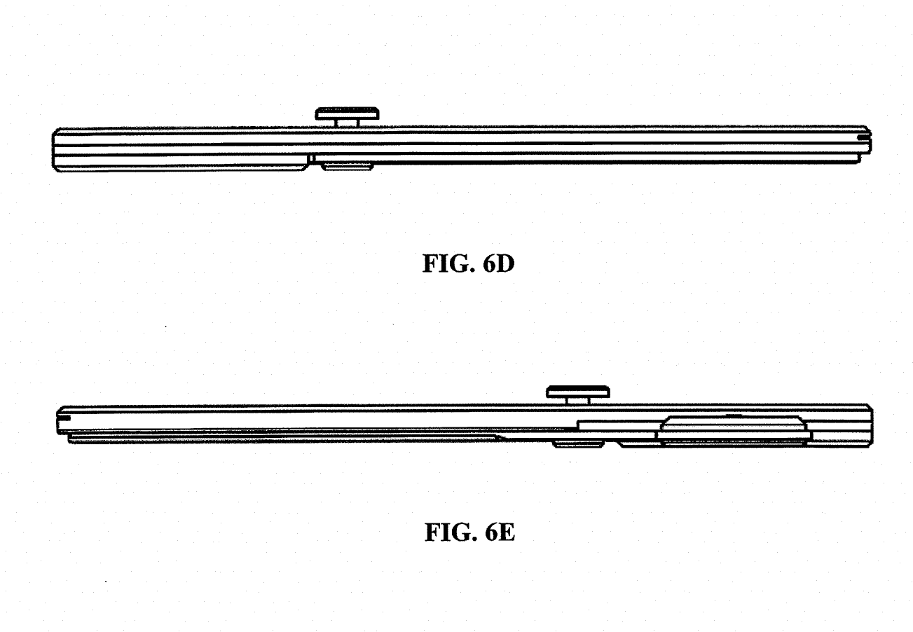

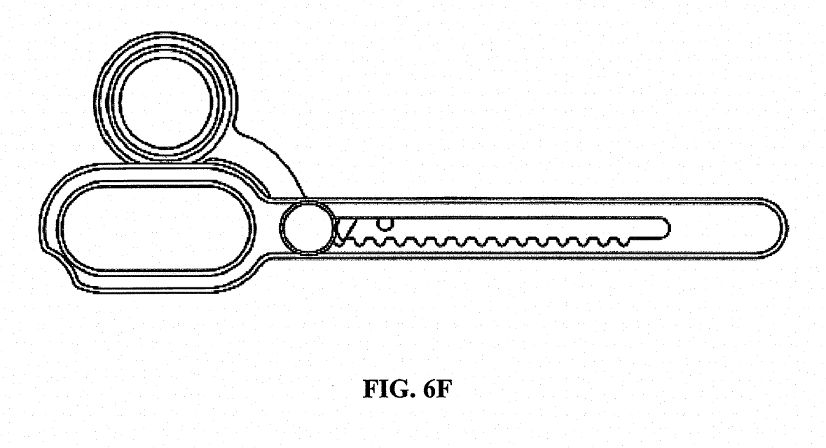

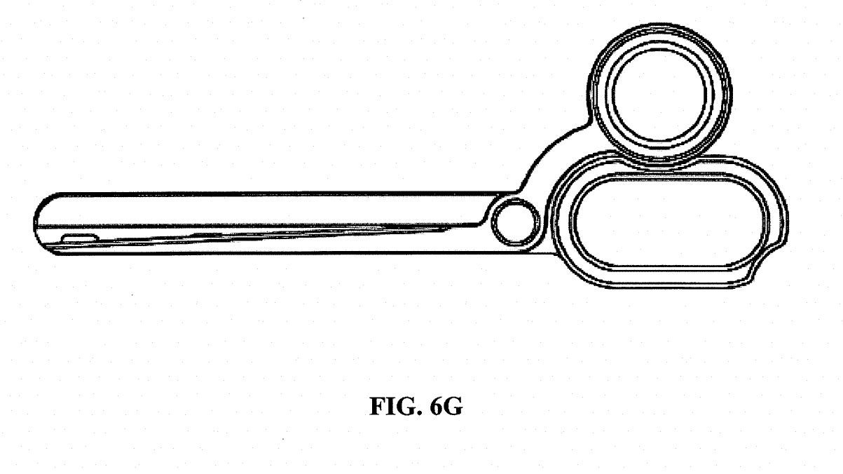

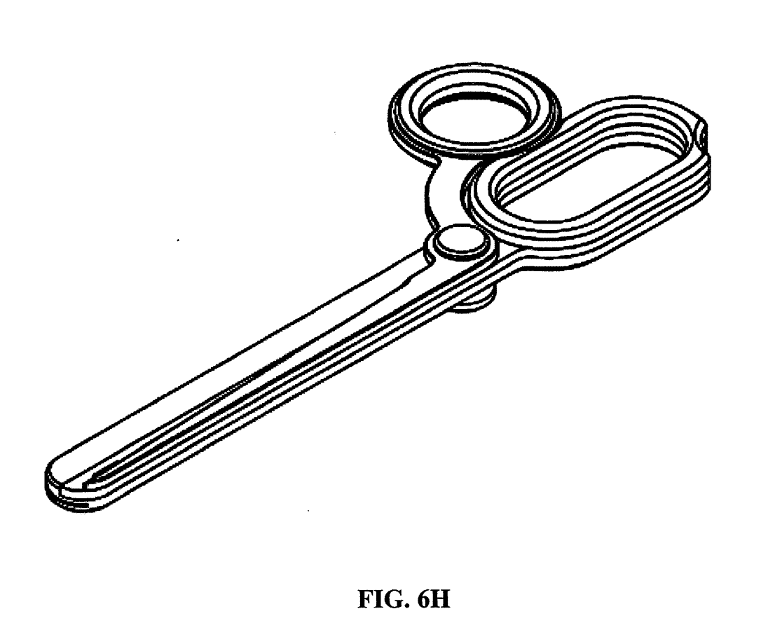

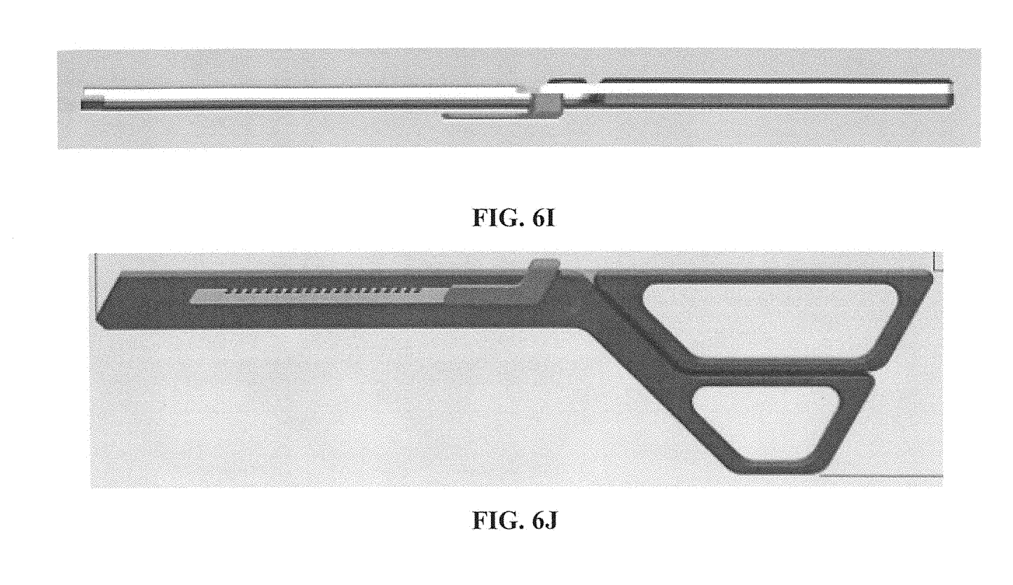

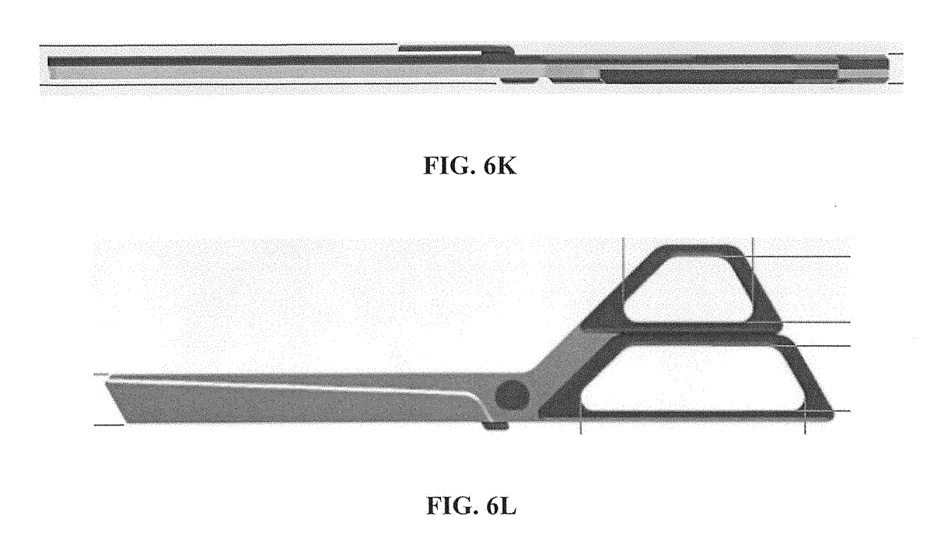

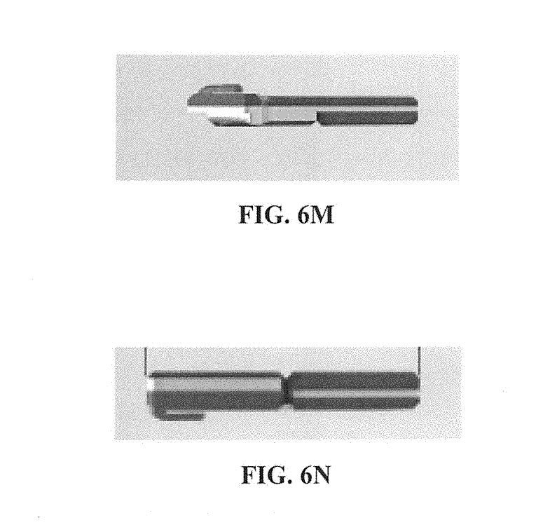

FIG. 5 shows a flowchart for replacement of cutting knife such as a multi-purpose utility knife 110. After wear occurs to cutting knife 110 embodiments allow for replacement of cutting knife 110. At step 580, channel cap 152 is removed. At step 582, cutting knife button 146 is depressed to enable sliding movement of knife 110 within channel 140 as describe above, and cutting knife 110 is moved rearward towards handle 132 until cutting knife button 146 is no longer within slot 144 and is located in the open interior of handle 132. At step 584, peg 155a of cutting knife button 146 can be disengaged from peg aperture 155b such that cutting knife 110 can move through channel 142 unencumbered. At step 586, the worn cutting knife 110 can be slid forward towards the end of scissor blade section 124 and fully removed out of the tip of scissor blade section 124. At step 588, a new cutting knife 110 can be inserted into the channel 142 entrance 143 of scissor blade section 124 and slide rearward towards the open interior of handle 132. At step 590, peg 155a of cutting knife button 146 can be engaged with peg aperture 155b of new cutting knife 110 and slid forward until engagement feature 150 is located within slot 144 and engaged with one of the plurality of cogs 148. At step 592, channel cap 152 is replaced. In alternative embodiments, the worn knife 110 can be removed and a new knife loaded from the proximal end of the channel 142 when channel cap 152 has been removed.

To use scissors 100 or 400 to shear cut, the user can open the scissors by exerting outward force on handles 122 or 422 and handles 132 or 432. Then, the material to be sheared can be placed between the scissor blade section 124 or 424 and scissor blade section 134 or 434. Then, the user can apply inward force on handles 122 or 422 and handles 132 or 432 to close the scissors and affecting a shear cut on the material.

To use scissors 100 or 400 to surface cut, as a box cutter or knife would, user can close the scissors by exerting inward force on handles 122 or 422 and handles 132 or 432. Then, the user can extend cutting knife 110 or 410 by depressing cutting knife button 146 or 446 such that engagement feature 150 or 450 is no longer engaged with a cog 148 or 448 of slot 144 or 444 and push cutting knife button 146 or 446 such that cutting knife 110 or 410 extends outwardly past cutting knife housing 140 or 440. Once cutting knife 110 or 410 is extended to a desired length, the user can release cutting knife button 146 or 446 such that engagement feature 150 is engages with a new cog 148 or 448 of slot 144 or 444. The user can then use scissors 100 or 400 to surface cut. When finished surface cutting, cutting knife 110 or 410 can be retracted in a similar fashion.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 15 U.S.C. § 112(f) are not to be invoked unless the specific terms “means for” or “step for” are recited in a claim.

1. A combination scissors and cutting knife comprising:
a first elongated member including a handle at a first end and a scissor blade section extending therefrom;
a second elongated member including a handle at a first end and a scissor blade section extending therefrom, the second elongated member pivotally coupled to the first elongated member;
a cutting knife housing extending from the handle of the second elongated member to a distal end of the scissor blade section of the second elongated member; and
a retractable cutting knife slidably contained within the cutting knife housing, the cutting knife selectively extendable from and retractable within the distal end of the scissor blade section of the second elongate member.

2. The combination scissors and cutting knife of claim 1, wherein the retractable cutting knife can be selectively fixed while extended out at a plurality of different lengths from the distal end of the scissor blade section of the second elongate member.

3. The combination scissors and cutting knife of claim 1, wherein the cutting knife housing is unitarily formed within a monolithic portion of the second elongated member.

4. The combination scissors and cutting knife of claim 1, wherein the retractable cutting knife is replaceable.

5. The combination scissors and cutting knife of claim 4, wherein the retractable cutting knife can be replaced by removing the retractable cutting knife from the cutting knife housing at the distal end of the scissor blade section of the second elongate member

6. The combination scissors and cutting knife of claim 1, wherein the cutting knife housing further defines a slot on an outer surface of the second elongated member.

7. The combination scissors and cutting knife of claim 6, further comprising a button extending through the slot to couple to the cutting knife, and wherein the cutting knife is slideable within the cutting knife housing by moving the button.

8. A combination scissors and cutting knife comprising:
a first elongated member including a handle at a first end and a scissor blade section at a second end;
a second elongated member including a handle at a first end and a scissor blade section at a second end, the second elongated member pivotally coupled to the first elongated member;
a third elongated member including a handle at a first end and a cutting knife housing at a second end, wherein the third elongated member and the second elongated member are coupled such that the handle of the third elongated member aligns with the handle of the second elongated member; and
a retractable cutting knife slidably contained within the cutting knife housing, the cutting knife selectively extendable from and retractable within a distal end of the cutting knife housing.

9. The combination scissors and cutting knife of claim 8, wherein the retractable cutting knife can be selectively fixed while extended out at a plurality of different lengths from the distal end of the cutting knife housing.

10. The combination scissors and cutting knife of claim 8, wherein the cutting knife housing is unitarily formed within a monolith portion of the third elongated member.

11. The combination scissors and cutting knife of claim 8, wherein the retractable cutting knife is replaceable.

12. The combination scissors and cutting knife of claim 8, wherein the retractable cutting knife can be replaced by removing the retractable cutting knife from the cutting knife housing at the distal end of the scissor blade section of the second elongate member

13. The combination scissors and cutting knife of claim 8, wherein the cutting knife housing extends from the handle of the third elongated member to a distal end of the third elongated member.

14. The combination scissors and cutting knife of claim 8, wherein the cutting knife housing further defines a slot on an outer surface of the second elongated member.

15. The combination scissors and cutting knife of claim 14, further comprising a button extending through the slot to couple to the cutting knife, and wherein the cutting knife is slideable within the cutting knife housing by moving the button.

16. A combination scissors and cutting knife comprising:
a first elongated member including a handle at a first end and a scissor blade section extending therefrom;
a second elongated member including a handle at a first end and a scissor blade section extending therefrom, the second elongated member pivotally coupled to the first elongated member, wherein the second elongate member defines a cutting knife housing therein, the cutting knife housing extending an entire length of the scissor blade section of the second elongated member; and
a retractable cutting knife slidably contained within the cutting knife housing, the cutting knife selectively extendable from and retractable within a distal end of the scissor blade section of the second elongate member.

17. The combination scissors and cutting knife of claim 16, wherein the retractable cutting knife can be selectively fixed while extended out at a plurality of different lengths from the distal end of the scissor blade section of the second elongate member.

18. The combination scissors and cutting knife of claim 17, wherein the cutting knife housing is unitarily formed within a monolithic portion of the second elongated member.

19. The combination scissors and cutting knife of claim 17, wherein the retractable cutting knife is replaceable.

20. The combination scissors and cutting knife of claim 19, wherein the retractable cutting knife can be replaced by removing the retractable cutting knife from the cutting knife housing at the distal end of the scissor blade section of the second elongate member
